(19) United States
(12) Patent Application Publication
(10) Pub. No.: US 2017/0364581 A1
(43) Pub. Date: Dec. 21, 2017

(54) METHODS AND SYSTEMS TO EVALUATE IMPORTANCE OF PERFORMANCE METRICS IN DATA CENTER

(71) Applicant: VMware, Inc., Palo Alto, CA (US)

(72) Inventors: Ashot Nshan Harutyunyan, Yerevan (AM); Arnak Poghosyan, Yerevan (AM); Naira Movses Grigoryan, Yerevan (AM); Hovhannes Antonyan, Yerevan (AM)

(73) Assignee: VMware, Inc., Palo Alto, CA (US)

(21) Appl. No.: 15/184,862

(22) Filed: Jun. 16, 2016

(51) Int. Cl. G06F 17/30; G06F 17/18

(52) U.S. Cl. CPC G06F 17/30601; G06F 17/18; G06F 17/3053

(57) ABSTRACT

Methods and systems to evaluate importance of metrics generated in a data center and ranking metric in order of relevance to data center performance are described. Methods collect sets of metric data generated in a data center over a period of time and categorize each set of metric data as being of high importance, medium importance, or low importance. Methods also calculate a rank ordering of each set of high importance and medium importance metric data. By determining importance of data center metrics, an optimal usage and distribution of computational and storage resources of the data center may be determined.

### TECHNICAL FIELD

The present disclosure is directed to ranking data center metrics in order to identify and resolve data center performance issues.

### BACKGROUND

Cloud-computing facilities provide computational bandwidth and data-storage services much as utility companies provide electrical power and water to consumers. Cloud computing provides enormous advantages to customers without the devices to purchase, manage, and maintain in-house data centers. Such customers can dynamically add and delete virtual computer systems from their virtual data centers within public clouds in order to track computational-bandwidth and data-storage needs, rather than purchase sufficient computer systems within a physical data center to handle peak computational-bandwidth and data-storage demands. Moreover, customers can avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a customer.

Because of an increasing demand for computational and data storage capacities by data center customers, a typical data center comprises thousands of server computers and mass storage devices. In order to monitor the vast numbers of server computers, virtual machines, and mass-storage arrays, data center management tools have been developed to collect and process very large sets of indicators in an attempt to identify data center performance problems. The indicators include millions of metrics generated by thousands of IT objects, such as server computers and virtual machines, and other data center resources. However, typical management tools treat all indicators with the same level of importance, which has led to inefficient use of data center resources, such as time, CPU, and memory, in an attempt to process all indicators and identify any performance problems.

### SUMMARY

Methods and systems described herein are directed evaluating importance of metrics generated in a data center and ranking metric in order of relevance to data center performance. Method collect sets of metric data generated in a data center over a period of time and categorize each set of metric data as being of high importance, medium importance, or low importance. Methods also calculate a rank ordering of each set of high importance and medium importance metric data. By determining importance of data center metrics, an optimal usage and distribution of computational and storage resources may be determined.

### DESCRIPTION OF THE DRAWINGS

FIG. 1 shows an example of a cloud-computing infrastructure.

FIG. 2 shows generalized hardware and software components of a server computer.

FIGS. 3A-3B show two types of virtual machines and virtual-machine execution environments.

FIG. 4 shows virtual machines and datastores above a virtual interface plane.

FIG. 5 shows a diagram of a method to determine a level of importance for groups of metrics.

FIG. 6 shows a plot of a set of metric data.

FIGS. 7A-7B shows plots of two sets of metric data.

FIGS. 8A-8B show plots of sets of metric data that are unsynchronized.

FIG. 9 shows an example of a correlation matrix.

FIG. 10 shows a correlation matrix C decomposed into Q and R matrices.

FIG. 11 shows diagonal elements of an R matrix sorted in descending order from largest to smallest magnitude.

FIG. 12 shows a set of metric data with changes in metric values between consecutive time stamps.

FIG. 13 shows a set of metric data and lower and upper thresholds.

FIG. 14 shows a portion of a set of metric data between two consecutive quantiles.

FIGS. 15A-15B show calculating a data-to-dynamic threshold alteration degree for a set of metric data over a historical time interval.

FIGS. 15C-15D show calculating a data-to-DT relation for a set of metric data over a current time interval.

FIG. 16 shows a flow diagram of a method to evaluate importance of data center metrics.

FIG. 17 shows a flow diagram of a routine “categorize each set of metric data as high, medium, or low importance” called in FIG. 16.

FIG. 18 shows a control-flow diagram of the routine “categorize low importance sets of metric data” called in FIG. 17.

FIG. 19 shows a control-flow diagram of the routine “categorize medium and high importance sets of metric data” called in FIG. 17.

FIG. 20 shows a control-flow diagram of the routine “calculate a rank of each set of high and medium importance metric data” called in FIG. 16.

FIG. 21 shows an architectural diagram for various types of computers that may be used to evaluate importance of data center metrics.

### DETAILED DESCRIPTION

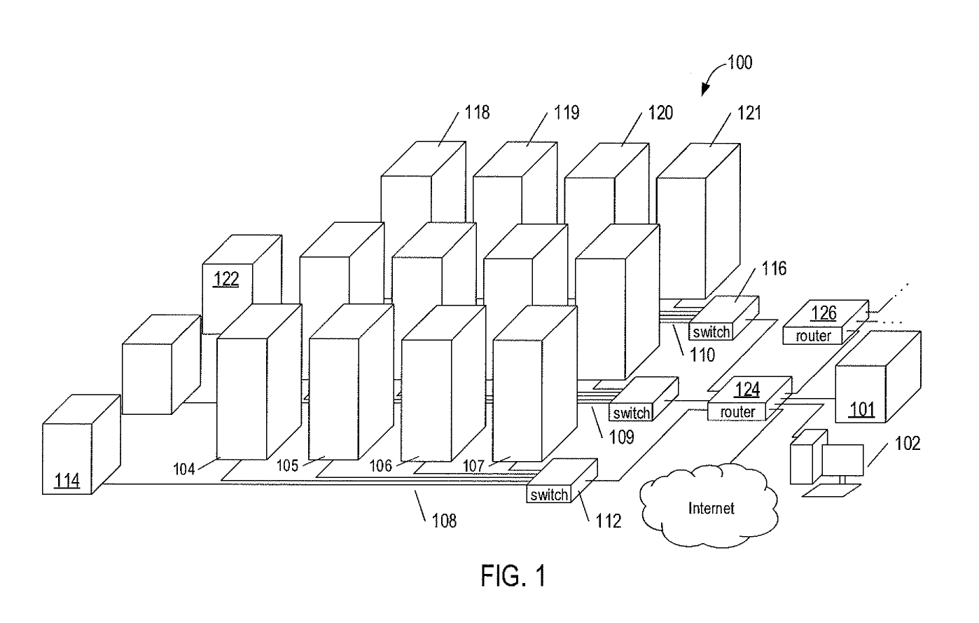

FIG. 1 shows an example of a cloud-computing infrastructure 100. The cloud-computing infrastructure 100 consists of a virtual-data-center management server 101 and a PC 102 on which a virtual-data-center management interface may be displayed to system administrators and other users. The cloud-computing infrastructure 100 additionally includes a number of hosts or server computers, such as server computers 104-107, that are interconnected to form three local area networks 108-110. For example, local area network 108 includes a switch 112 that interconnects the four servers 104-107 and a mass-storage array 114 via Ethernet or optical cables and local area network 110 includes a switch 116 that interconnects four servers 118-1121 and a mass-storage array 122 via Ethernet or optical cables. In this example, the cloud-computing infrastructure 100 also includes a router 124 that interconnects the LANs 108-110 and interconnects the LANS to the Internet, the virtual-data-center management server 101, the PC 102 and to a router 126 that, in turn, interconnects other LANs composed of server computers and mass-storage arrays (not shown). In other words, the routers 124 and 126 are interconnected to form a larger network of server computers.

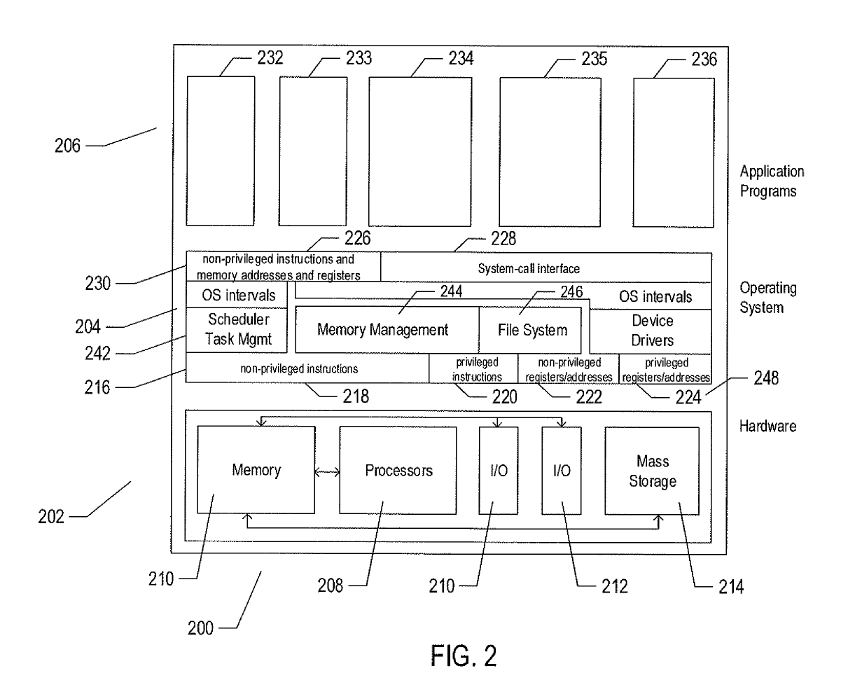

FIG. 2 shows generalized hardware and software components of a server computer. The server computer 200 includes three fundamental layers: (1) a hardware layer or level 202; (2) an operating-system layer or level 204; and (3) an application-program layer or level 206. The hardware layer 202 includes one or more processors 208, system memory 210, various different types of input-output (“I/O”) devices 210 and 212, and mass-storage devices 214. Of course, the hardware level also includes many other components, including power supplies, internal communications links and busses, specialized integrated circuits, many different types of processor-controlled or microprocessor-controlled peripheral devices and controllers, and many other components. The operating system 204 interfaces to the hardware level 202 through a low-level operating system and hardware interface 216 generally comprising a set of non-privileged computer instructions 218, a set of privileged computer instructions 220, a set of non-privileged registers and memory addresses 222, and a set of privileged registers and memory addresses 224. In general, the operating system exposes non-privileged instructions, non-privileged registers, and non-privileged memory addresses 226 and a system-call interface 228 as an operating-system interface 230 to application programs 232-236 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 242, memory management 244, a file system 246, device drivers 248, and many other components and modules.

To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 246 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

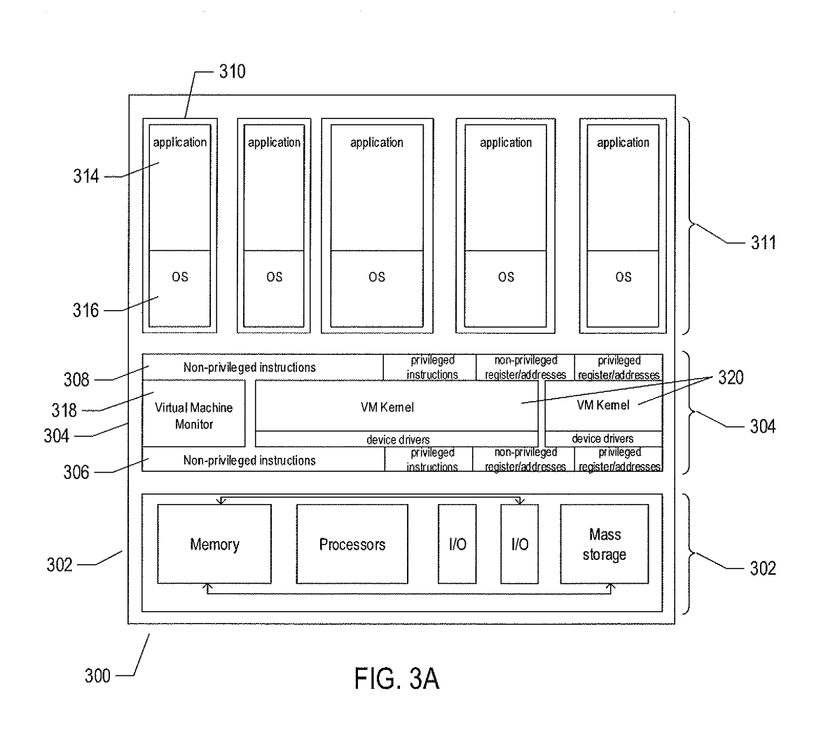

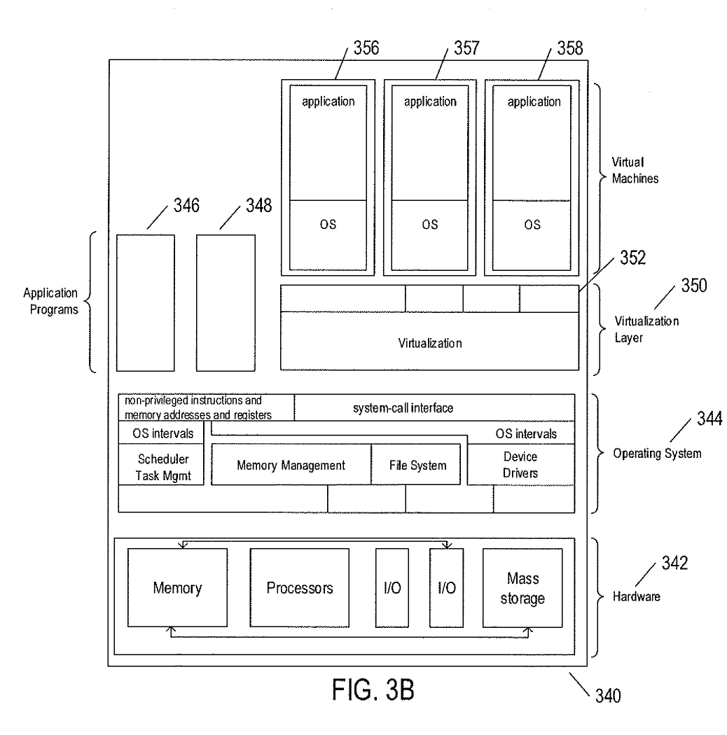

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 3A-3B show two types of VM and virtual-machine execution environments. FIGS. 3A-3B use the same illustration conventions as used in FIG. 2. FIG. 3A shows a first type of virtualization. The server computer 300 in FIG. 3A includes the same hardware layer 302 as the hardware layer 202 shown in FIG. 2. However, rather than providing an operating system layer directly above the hardware layer, as in FIG. 2, the virtualized computing environment shown in FIG. 3A features a virtualization layer 304 that interfaces through a virtualization-layer/hardware-layer interface 306, equivalent to interface 216 in FIG. 2, to the hardware. The virtualization layer 304 provides a hardware-like interface 308 to a number of VMs, such as VM 310, in a virtual-machine layer 311 executing above the virtualization layer 304. Each VM includes one or more application programs or other higher-level computational entities packaged together with an operating system, referred to as a “guest operating system,” such as application 314 and guest operating system 316 packaged together within VM 310. Each VM is thus equivalent to the operating-system layer 204 and application-program layer 206 in the general-purpose computer system shown in FIG. 2. Each guest operating system within a VM interfaces to the virtualization-layer interface 308 rather than to the actual hardware interface 306. The virtualization layer 304 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 304 ensures that each of the VMs currently executing within the virtual environment receive a fair allocation of underlying hardware devices and that all VMs receive sufficient devices to progress in execution. The virtualization-layer interface 308 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 304 includes a virtual-machine-monitor module 318 that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization-layer interface 308, the accesses result in execution of virtualization-layer code to simulate or emulate the privileged devices. The virtualization layer additionally includes a kernel module 320 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 304 essentially schedules execution of VMs much like an operating system schedules execution of application programs, so that the VMs each execute within a complete and fully functional virtual hardware layer.

FIG. 3B shows a second type of virtualization. In FIG. 3B, the server computer 340 includes the same hardware layer 342 and operating system layer 344 as the hardware layer 202 and the operating system layer 204 shown in FIG. 2. Several application programs 346 and 348 are shown running in the execution environment provided by the operating system 344. In addition, a virtualization layer 350 is also provided, in computer 340, but, unlike the virtualization layer 304 discussed with reference to FIG. 3A, virtualization layer 350 is layered above the operating system 344, referred to as the “host OS,” and uses the operating system interface to access operating-system-provided functionality as well as the hardware. The virtualization layer 350 comprises primarily a VMM and a hardware-like interface 352, similar to hardware-like interface 308 in FIG. 3A. The virtualization-layer/hardware-layer interface 352, equivalent to interface 216 in FIG. 2, provides an execution environment for a number of VMs 356-358, each including one or more application programs or other higher-level computational entities packaged together with a guest operating system.

In FIGS. 3A-3B, the layers are somewhat simplified for clarity of illustration. For example, portions of the virtualization layer 350 may reside within the host-operating-system kernel, such as a specialized driver incorporated into the host operating system to facilitate hardware access by the virtualization layer.

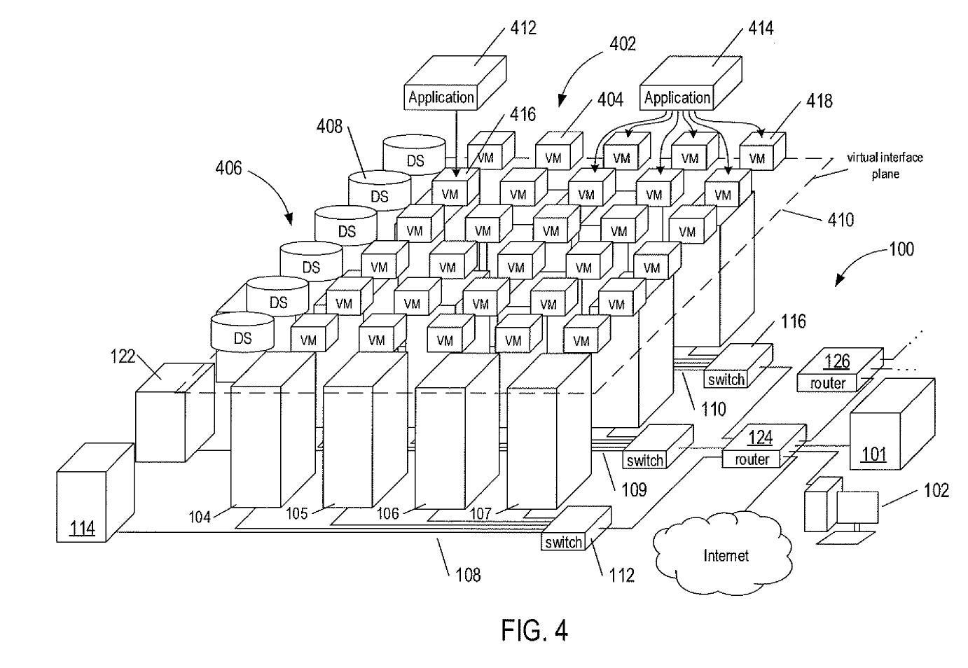

FIG. 4 shows an example set of VMs 402, such as VM 404, and a set of datastores (“DS”) 406, such as DS 408, above a virtual interface plane 410. The virtual interface plane 410 represents a separation between a physical resource level that comprises the server computers and mass-data storage arrays and a virtual resource level that comprises the VMs and DSs. The set of VMs 402 may be partitioned to run on different server computers, and the set of DSs 406 may be partitioned on different mass-storage arrays. Because the VMs are not bound physical devices, the VMs may be moved to different server computers in an attempt to maximize efficient use of the cloud-computing infrastructure 100 resources. For example, each of the server computers 104-107 may initially run three VMs. However, because the VMs have different workloads and storage requirements, the VMs may be moved to other server computers with available data storage and computational resources. Certain VMs may also be grouped into resource pools. For example, suppose a host is used to run five VMs and a first department of an organization uses three of the VMs and a second department of the same organization uses two of the VMs. Because the second department needs larger amounts of CPU and memory, a systems administrator may create one resource pool that comprises the three VMs used by the first department and a second resource pool that comprises the two VMs used by the second department. The second resource pool may be allocated more CPU and memory to meet the larger demands. FIG. 4 shows two application programs 412 and 414. Application program 412 runs on a single VM 416. On the other hand, application program 414 is a distributed application that runs on six VMs, such as VM 418.

A typical data center may comprise thousands of objects, such as server computers and VMs, that collectively generate potentially millions of metrics that may be used as performance indicators. Each metric is time series data that is stored and used to generate recommendations. Because of vast number of metrics, a tremendous amount of data center resources (time, CPU usage, memory) are used to process these metrics in an attempt to measure, learn, and generate recommendations that does not necessarily increase data center management efficiency. For example, data center management tools have to manage huge data center customer application programs, process millions of different time series metric data, store months of time series metric data, and determine behavioral patterns from the vast amounts of metric data in an attempt to spot data center performance problems. Current data center management tools treat all metrics with the same level of importance, resulting in high resource consumption and recommendations that are not prioritized into actionable scenarios.

Methods categorize metrics as high importance, medium importance, and low importance and rank metrics within certain importance categories. Certain high importance and medium importance metrics may be identified as key performance indicators, which are considered the most important indicators of data center performance. Methods to categorize the importance of different metrics and rank metrics within certain importance categories may enable more efficient distribution of data resource resources in predictive analytics, resolves data compression issues, and generate recommendations that address performance issues. In addition, importance categories may be used to recommend default and smart policies to data center customers. The gains obtained from identifying metrics as belonging to the different importance categories improves many aspects of infrastructure management by:

1) providing optimized recommendation at a post-event phase (e.g., alarms, problem alerts) by focusing on the highest importance metrics and associated events and/or consolidate recommendations across the various importance categories; and

2) providing optimized data management and predictive analytics in order to allocate computational resources of data processing and DT-analytics subject to the importance/group priority; stopping the DT analytics for the less important groups; delegating low-cost plugins (like automated time-independent thresholding); and improve metrics storage/compression approaches subject to the preserved fidelity of information.

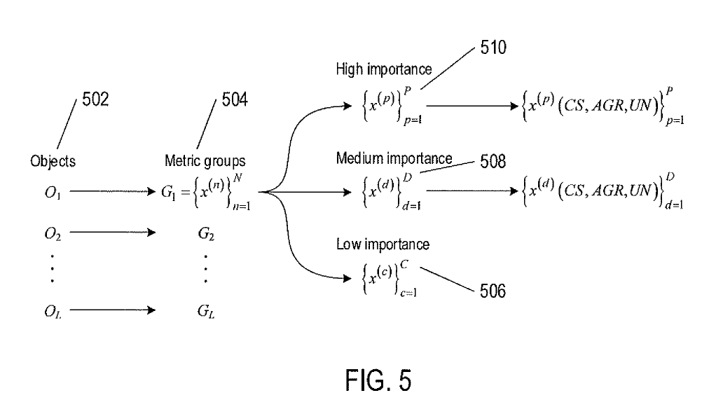

The metrics are divided into metric groups. Each metric group comprises sets of time-series metric data associated with an object of the data center. FIG. 5 shows a diagram of a method to determine a level of importance for groups of metrics. Column 502 is a list of L data center objects denoted by O₁, . . . , O_{L}. An object may be a computer server or a VM. Column 504 is a list of L metric groups denoted by G₁, . . . , G_{L}. Each metric group is associated with a corresponding object, as indicated by directional arrows, and comprises sets of time-series metric data. For example, the metric group G₁ is composed of N sets of metric data denoted by

G₁={x⁽ⁿ⁾(t)}ₙ₌₁^{N} (1)

where x⁽ⁿ⁾(t) denotes the n-th set of time series metric data.

Each set of metric data x⁽ⁿ⁾(t) represents usage or performance of the object O₁ in the cloud-computing infrastructure 100. Each set of metric data is time-series data represented by

x⁽ⁿ⁾(t)={x⁽ⁿ⁾(tₖ)}ₖ₌₁^{K}={xₖ⁽ⁿ⁾}ₖ₌₁^{K} (2)

where
xₖ⁽ⁿ⁾=x⁽ⁿ⁾(tₖ) represents a metric value at the k-th time stamp tₖ; and
K is the number of time stamps in the set of metric data.

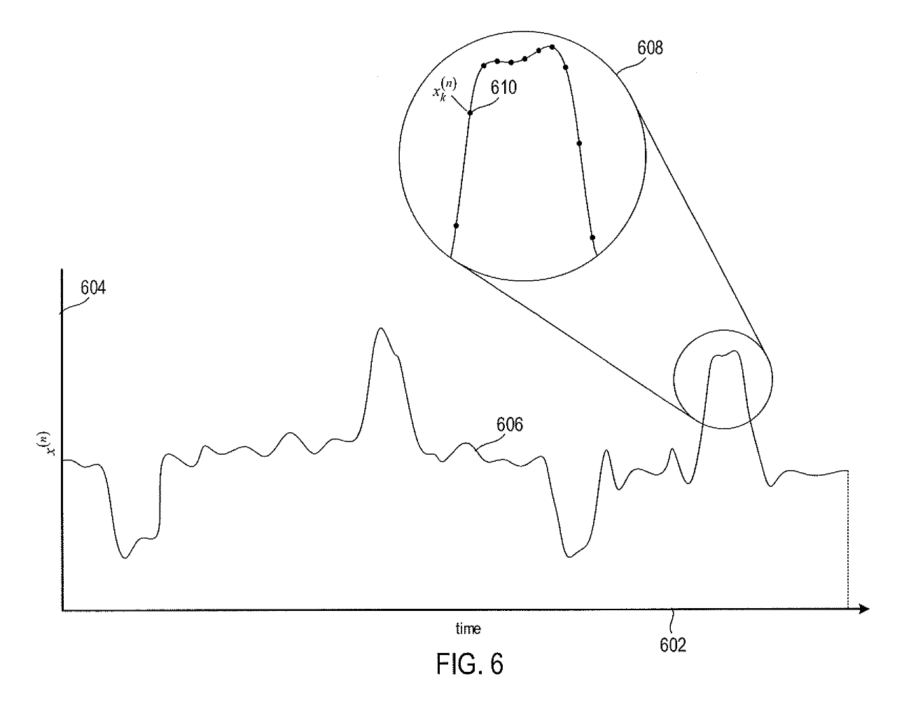

FIG. 6 shows a plot of an n-th set of metric data. Horizontal axis 602 represents time. Vertical axis 604 represents a range of metric values. Curve 606 represents a set of time-series metric data generated by the cloud-computing infrastructure 100 over a period of time. FIG. 6 includes a magnified view 608 of metric values. Each dot, such as solid dot 610, represents a metric values xₖ⁽ⁱ⁾ at a time stamp tₖ. Each metric value represents a usage level or a measurement of the object at a time stamp.

Returning to FIG. 5, subsets of the N sets of metric data {x⁽ⁿ⁾(t)}ₙ₌₁^{N} are categorized as high importance sets of, medium importance, and low importance metric data denoted by

{x⁽ⁿ⁾(t)}ₙ₌₁^{N}={x^{(p)}(t)}ₚ₌₁^{P}∪{x^{(d)}(t)}_{d=1}^{D}∪{x^{(c)}(t)}_{c=1}^{C} (3)

where
{x^{(p)}(t)}ₚ₌₁^{P} comprises high importance sets of metric data 510;
{x^{(d)}(t)}_{d=1}^{D} comprises medium importance sets metric data 508;
{x^{(c)}(t)}_{c=1}^{C} comprises low importance sets metric data 506; and
N=P+D+C.

The subset of low importance metric data {x^{(c)}(t)}_{c=1}^{C} comprises the sets of metric data in G₁ with little to no variability and are regarded as low importance metric data. Low importance metric data in the sets of metric data may be identified by calculating the standard deviation for each set of metric data in the metric group G₁. The standard deviation of a set of metric data x⁽ⁿ⁾(t) may be calculated as follows:

$${σ}^{( n )} = \sqrt{\frac{1}{K - 1} {\sum }_{k = 1}^{K} {( {x}_{k}^{( n )} - {μ}^{( n )} )}^{2}} \qquad ( 4 a )$$

where the mean value of the set of metric data is given by:

$${μ}^{( n )} = \frac{1}{K} {\sum }_{k = 1}^{K} {x}_{k}^{( n )} \qquad ( 4 b )$$

When the standard deviation satisfies the condition given by

εₛₜ≧σ⁽ⁿ⁾ (5a)

where εₛₜ is a low-variability threshold (e.g., εₛₜ=0.01), the variability of the set of metric data x⁽ⁿ⁾(t) is low and the set of metric data is categorized as a low importance. Otherwise, when the standard deviation satisfies the condition

σ⁽ⁿ⁾>εₛₜ (5b)

the set of metric data x⁽ⁿ⁾(t) may be checked to determine if the set of metric data x⁽ⁿ⁾(t) is medium importance or high importance metric data.

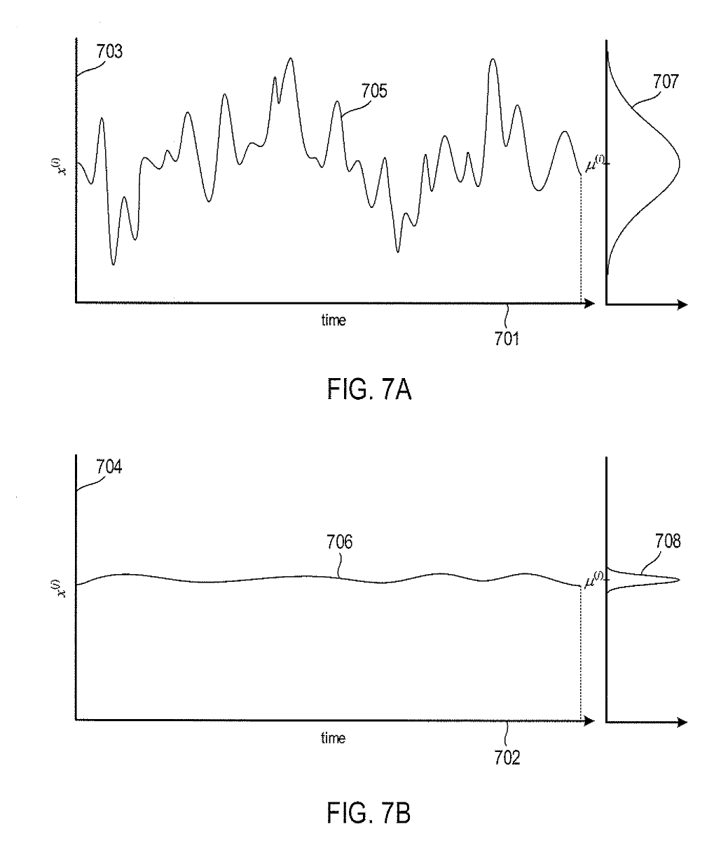

FIGS. 7A-7B shows plots of two sets of metric data. Horizontal axes 701 and 702 represent time. Vertical axis 703 represents a range of metric values for a first set of metric data x⁽ⁱ⁾(t) and vertical axis 704 represents the same range of metric values for a second set of metric data x^{(j)}(t). Curve 705 represents the set of metric data x⁽ⁱ⁾(t) and curve 706 represents the set of metric data x^{(j)}(t). FIG. 7A includes an example first distribution 707 of metric values of the first set of metric data centered about a mean value μ⁽ⁱ⁾. FIG. 7B includes a second distribution 708 of metric values of the second set of metric data centered about a mean value μ^{(j)}. The distributions 707 and 708 reveal that the first set of metric data 705 has a much higher degree of variability than the second set of metric data. As a result, the standard deviation σ⁽ⁱ⁾ of the first set of metric data 705 is much larger than the standard deviation σ^{(j)} of the second set of metric data 706. The second set of metric data 706 has low variability and may be categorized as a low importance set of metric data.

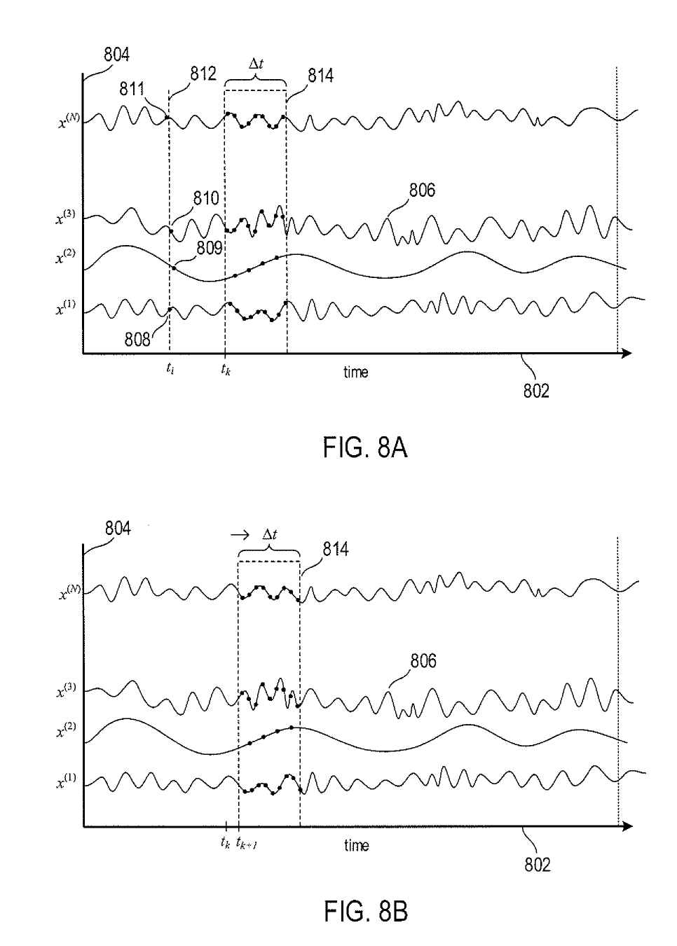

Before the remaining sets of metric data in the metric group G₁ can be categorized as either high importance or medium importance, the sets of metric data are synchronized in time. FIGS. 8A-8B show a plot of example sets of metric data that are not synchronized with the same time stamps. Horizontal axis 802 represents time. Vertical axis 804 represents sets of metric data. Curves, such as curve 806, represent different sets of metric data. Dots represent metric values recorded at different time stamps. For example, dot 808 represents a metric value recorded at time stamp tᵢ. Dots 809-811 also represents metric values recorded for each of the other sets of metric data with time stamps closest to the time stamp represented by dashed line 812. However, in this example, because the metric values were recorded at different times, the time stamps of the metric values 809-811 are not aligned in time with the time stamp tᵢ. Dashed-line rectangle 814 represents a sliding window with time width Δt. For each set of metric data, the metric values with time stamps that lie within the sliding time window are smoothed and assigned the earliest time defined by the sliding time window. In one implementation, the metric values with time stamps in the sliding time window may be smoothed by computing an average as follows:

$${x}^{( n )} ( {t}_{k} ) = \frac{1}{H} {\sum }_{h = 1}^{H} {x}^{( n )} ( {t}_{h} ) \qquad ( 6 )$$

where
tₖ≦tₕ≦tₖ+Δt; and
H is the number of metric values in the time window.
   In an alternative implementation, the metric values with time stamps in the sliding time window may be smoothed by computing a median value as follows:

x⁽ⁿ⁾(tₖ)=median{x⁽ⁿ⁾(tₕ)}ₕ₌₁^{H} (7)

After the metric values of the sets of metric data have been smoothed for the time window time stamp tₖ, the sliding time window is incrementally advance to next time stamp tₖ₊₁, as shown in FIG. 8B. The metric values with time stamps in the sliding time window are smoothed and the process is repeated until the sliding time window reaches a final time stamp tₖ.

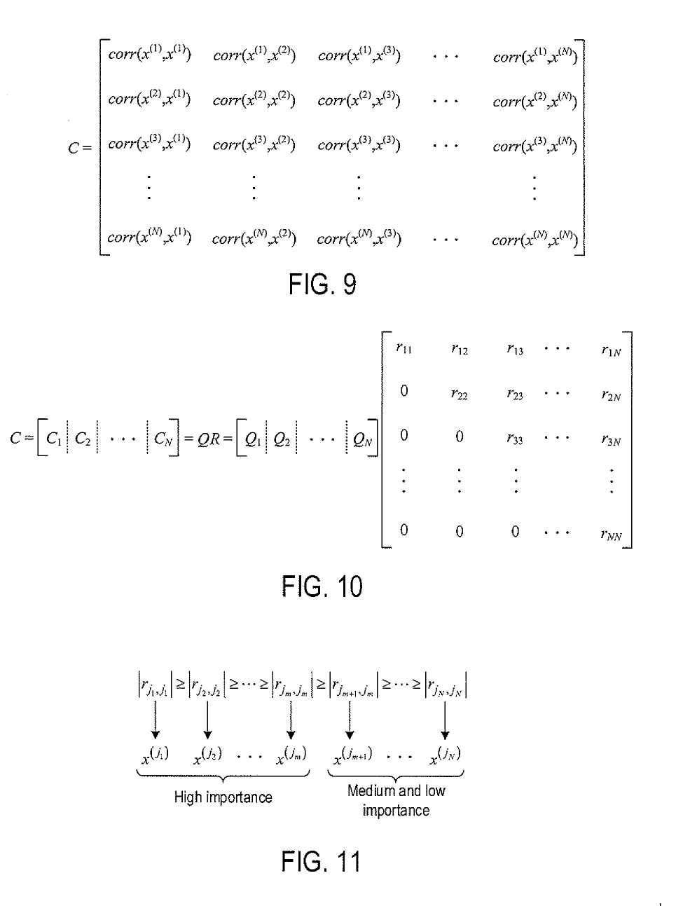

A correlation matrix of the synchronized sets of metric data is calculated. FIG. 9 shows an example of an N×N correlation matrix C of N sets of metric data. Each element of the correlation matrix C may be calculated as follows:

$$corr ( {x}^{( i )} , {x}^{( j )} ) = \frac{{\sum }_{k = 1}^{n} ( {x}_{k}^{( i )} - {μ}^{( i )} ) ( {x}_{k}^{( j )} - {μ}^{( j )} )}{{σ}^{( i )} {σ}^{( j )}} \qquad ( 8 )$$

The N eigenvalues of the correlation matrix are given by

{λₙ}ₙ₌₁^{N} (9)

where the eigenvalues are arranged from largest to smallest (i.e., λₙ≧λₙ₊₁ for n=1, . . . , N).

Because the correlation matrix C is symmetric and positive-semidefinite, the eigenvalues are non-zero. The number of non-zero eigenvalues of the correlation matrix is the rank of the correlation matrix given by

rank(C)=m (10)

For a rank in, the eigenvalues may be satisfy the following condition:

$$\begin{matrix}\frac{{λ}_{1} + … + {λ}_{m - 1}}{N} < τ & ( 11 a ) \\ \frac{{λ}_{1} + … + {λ}_{m - 1} + {λ}_{m}}{N} \geq τ & ( 11 b )\end{matrix}$$

where τ is a predefined tolerance 0<τ≦1.

In particular, the tolerance τ may be in an interval 0.8≦r≦1. The rank in indicates that the set of metric data {x⁽ⁿ⁾(t)}ₙ₌₁^{N} has in independent sets of metric data that are the high importance sets of metric data. The remaining sets of metric data that have not already been categorized as low importance sets metric data are categorized as medium importance sets metric data.

Given the numerical rank in, the in high importance sets of metric data may be determined using QR decomposition of the correlation matrix C. In particular, the in high importance sets of metric data are determined based on the in largest diagonal elements of the R matrix obtained from QR decomposition.

FIG. 10 shows the correlation matrix of FIG. 9 decomposed into Q and R matrices that result from QR decomposition of the correlation matrix C. The N columns of the correlation matrix C are denoted by C₁, C₂, . . . , C_{N}, N columns of the Q matrix are denoted by Q₁, Q₂, . . . , Q_{N} and N diagonal elements of the R matrix are denoted by r₁₁, r₂₂, . . . , r_{NN}. The columns of the Q matrix are calculated from the columns of the correlation matrix as follows:

$${Q}_{i} = \frac{{U}_{i}}{‖ {U}_{i} ‖} \qquad ( 12 a )$$

where
∥Uᵢ∥ denotes the length of a vector Uᵢ; and
the vectors Uᵢ are iteratively calculated according to

$$\begin{matrix}{U}_{1} = {C}_{1} & ( 12 b ) \\ {U}_{i} = {C}_{i} - {\sum }_{j = 1}^{i - 1} \frac{〈 {Q}_{j} , {C}_{j} 〉}{〈 {Q}_{j} , {Q}_{j} 〉} {Q}_{j} & ( 12 c )\end{matrix}$$

where [symbol] •,• [symbol] denotes the scalar product.

The diagonal elements of the R matrix are given by

rᵢᵢ= [symbol] Qᵢ,Cᵢ [symbol] (12d)

The absolute values of the diagonal elements of the R matrix are sorted in descending order as follows:

|rⱼ_{₁}_{,j}_{₁}|≧|rⱼ_{₂}_{,j}_{₂}|≧ . . . ≧|rⱼ_{ₘ}_{,j}_{ₘ}|≧|≧|rⱼ_{ₘ₋₁}_{,j}_{ₘ₋₁}|≧ . . . ≧|rⱼ_{_{N}}_{,j}_{_{N}}| (13)

where
j₁, . . . , j_{N} are indices of the R matrix;
‥•| is the absolute value;
   |rⱼ_{₁}_{,j}_{₁}| is the diagonal element of the R matrix with the largest magnitude;
   |rⱼ_{ₘ}_{,j}_{ₘ}| is the diagonal element of the R matrix with the m-th largest magnitude; and
   |rⱼ_{_{N}}_{,j}_{_{N}}| is the diagonal element of the R matrix with the smallest magnitude.
   The sets of metric data that corresponds to the m-th (i.e., numerical rank) largest magnitude diagonal elements of the R matrix are the high importance sets of metric data.

FIG. 11 shows diagonal elements of an R matrix sorted in descending order from largest to smallest magnitude. Directional arrows represent the in largest magnitude diagonal elements correspondence with m sets of metric data. For example, suppose the magnitude of a diagonal matrix element |r_{5,5}|≧|rⱼ_{ₘ}_{,j}_{ₘ}|. The set of metric data x⁽⁵⁾(t) would be categorized as a high importance set of metric data. The sets of metric data with corresponding diagonal elements that are less than |rⱼ_{ₘ}_{,j}_{ₘ}| are a combination of low and medium importance sets of metric data. The sets of metric data that have not already been categorized as low importance, as described above with reference to Equations (4)-(5), are categorized as medium importance sets of metric data.

Returning to FIG. 5, for each set of metric data in the medium and high importance sets of metric data 508 and 510, a change score (“CS”), anomaly generation rate (“AGR”), and uncertainty (“UN”) are calculated. The change score, anomaly generation rate, and uncertainty values calculated for each high importance set of metric data and each medium importance set of metric data may be used to rank the sets of metric within each of importance levels.

A change score may be calculated as the number of metric values that change between consecutive time stamps over the total number of all metric values in the set of metric data minus 1 and is represented by

$$CS ( {x}^{( i )} ( t ) ) = \frac{\sum A}{K - 1} \\ where \\ A = \{ \begin{matrix}1 & if \vert {x}_{k}^{( i )} - {x}_{k + 1}^{( i )} \vert \neq 0 \\ 0 & if \vert {x}_{k}^{( i )} - {x}_{k + 1}^{( i )} \vert = 0\end{matrix} \qquad ( 14 )$$

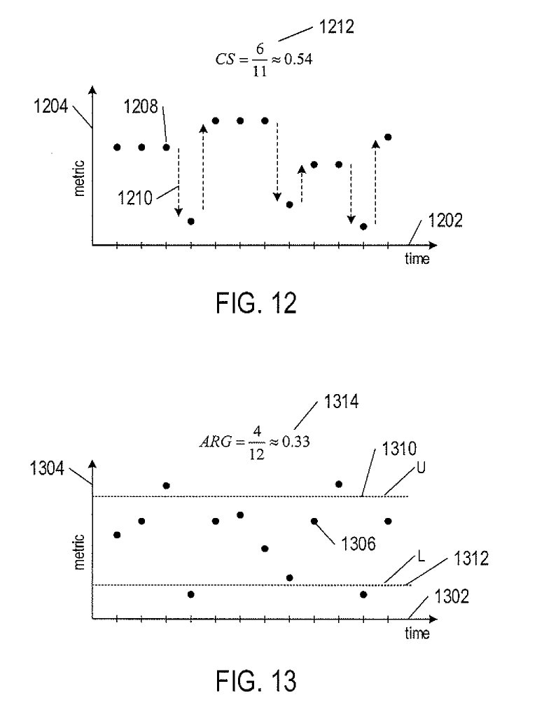

FIG. 12 shows a set of metric data with changes in metric values between consecutive time stamps. Horizontal axis 1202 represents time. Vertical axis 1204 represents a range of metric values. Dots, such as dot 1206, represent metric values of the set of metric data at time stamps represented by marks along the time axis 1202. Each down and up dashed-line directional arrow, such as directional arrow 1208, represents a change in metric value from one to time stamp to a next time stamp. These changes in metric values are summed to obtain the numerator of the change score in Equation (14). In this example, the number of Equation (14) is “6.” According to the Equation (14), a change score 1212 is calculated as approximately 0.54.

The anomaly generation rate may be calculated as the number of metric values of a set of metric data that violate an upper threshold, U, and/or a lower threshold, L as follows:

$$AGR ( {x}^{( i )} ( t ) ) = \frac{1}{K} \sum {X}_{viol} where \\ {X}_{viol} = \{ \begin{matrix}1 & if L \leq {x}_{k}^{( i )} \leq U \\ 0 & if {x}_{k}^{( i )} < L or U < {x}_{k}^{( i )}\end{matrix} \qquad ( 15 )$$

FIG. 13 shows a set of metric data and lower and upper thresholds. Horizontal axis 1302 represents time. Vertical axis 1304 represents a range of metric values. Dots, such as dot 1306, represent metric values of the set of metric data at time stamps represented by marks along the time axis 1302. Dashed line 1310 represents the upper threshold U and dashed line 1312 represents the lower threshold L of the set of metric data. According to Equation (15), the anomaly generation rate 1314 is approximately 0.33.

An uncertainty may be calculated for the set of metric data x⁽ⁱ⁾(t) over the data range from the 0^{th} to 100^{th} quantile as follows:

$$UN ( {x}^{( i )} ( t ) ) = - {\sum }_{s = 1}^{100} {v}_{s} {log}_{100} {v}_{s} \\ where {v}_{s} = \frac{K ( {q}_{s - 1} , {q}_{s} )}{K} \qquad ( 16 )$$

s=1, . . . , 100; and

K(qₛ₋₁,qₛ) is the number of metric values between the qₛ₋₁ and qₛ quantiles of the set of metric data x⁽ⁱ⁾(t).

The quantity vₛ represents the fraction of the metric values in the set of the metric data x⁽ⁱ⁾(t) between the qₛ₋₁ and qₛ quantiles. The uncertainty calculated according to Equation (17) of the set of metric data x⁽ⁱ⁾(t) in terms of predictability of the range of metric values that can be measured is the entropy of the distribution V=(v₁, v₂, . . . , v₁₀₀).

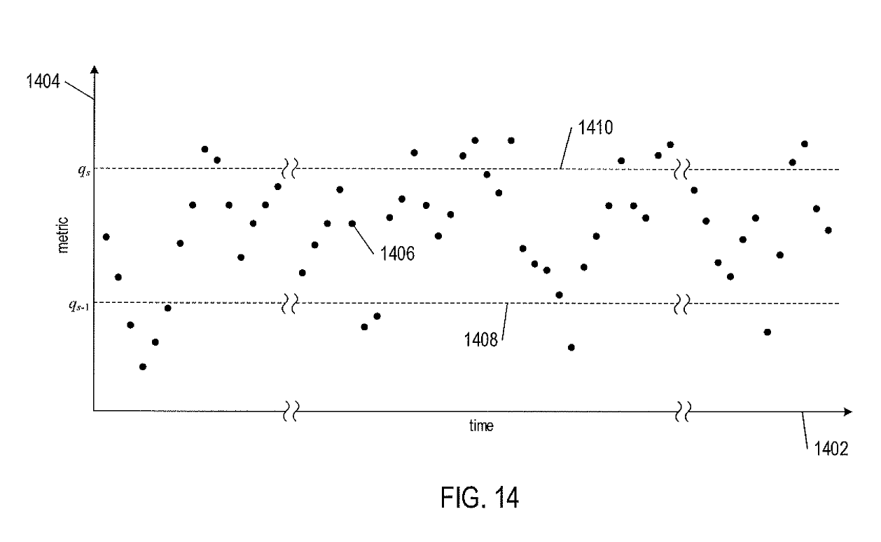

FIG. 14 shows a portion of a set of metric data between two consecutive quantiles qₛ₋₁ and qₛ. Horizontal axis 1402 represents time. Vertical axis 1404 represents a range of metric values. Dots, such as dot 1406, represent metric values of the set of metric data. Dashed lines 1408 represents the quantile qₛ₋₁ and dashed line 1410 represents the quantile q₅. The numerator K(qₛ₋₁,qₛ.) in Equation (16) is the number of metric values of the set of metric data that lie between the quantiles qₛ₋₁ and q₅.

The change score, anomaly generation rate, and uncertainty calculated for each high importance set of metric data and medium importance set of metric data may be used to calculate an importance rank of each high importance and medium importance set of metric data. The rank of each high importance and medium importance set of metric data may be calculated as a linear combination of change score, anomaly generation rate, and uncertainty as follows:

rank(x⁽ⁱ⁾(t))=w_{CS}CS(x⁽ⁱ⁾(t))+w_{ARG}AGR(x⁽ⁱ⁾(t)+w_{UN}UN(x⁽ⁱ⁾(t)) (17)

where w_{CS}, w_{ARG} and w_{UN} are change score, anomaly generation rate, and uncertainty weights.

Alternatively, the rank of each high importance set of metric data and medium importance set of metric data may be calculated as a product of change score, anomaly generation rate, and uncertainty value as follows:

rank(x⁽ⁱ⁾(t))=CS(x⁽ⁱ⁾(t))AGR(x⁽ⁱ⁾(t))UN(x⁽ⁱ⁾(t)) (18)

A set of metric data with a rank that satisfies the condition

rank(x⁽ⁱ⁾(t))≧Th_{KPI} (19)

where Th_{KPI} is a key performance indicator threshold,

may be identified as a key performance indicator.

The set of metric data with a higher rank than another set of metric data in the same importance level may be regarded as being of higher importance. For example, consider a first set of metric data x⁽ⁱ⁾(t) and a second set of metric data x^{(j)}(t) categorized as high importance sets of metric data. The first set of metric x⁽ⁱ⁾(t) may be categorized as being of more importance (i.e., higher rank) than the second set of metric data x^{(j)}(t) when rank (x⁽ⁱ⁾(t))>rank (x^{(j)}(t)).

Each VM running in a data center has a set of attributes. Methods described above may be used to assign importance ranks to object attributes. The attributes of a VM include CPU usage, memory usage, and network usage, each of which has an associated set of time series metric data:

a_{Y}⁽ⁱ⁾(t)={a_{Y}⁽ⁱ⁾(tₖ)}ₖ₌₁^{K} (20)

where
the subscript “Y” represents CPU usage, memory usage, or network usage;
a_{Y}⁽ⁱ⁾(tₖ) represents a metric value measured at the k-th time stamp tₖ; and
K is the number of time stamps in the set of metric data.
   For example, three attributes of a VM are time series data of CPU usage, memory usage, and network bandwidth. The importance rank of an attribute in a data center may be calculated as the average of importance ranks of all metrics representing the attribute in the data center:

$$rank ( {a}_{Y} ) = \frac{1}{M} {\sum }_{i = 1}^{M} rank ( {a}_{Y}^{( i )} ) \qquad ( 21 )$$

where rank(a_{Y}⁽ⁱ⁾) is the importance rank of the attribute calculated as described above; and
M is the number of Y-type attributes in the data center.

Typical data center management tools calculate dynamic thresholds (“DTs”) for each set of metric data based data recorded over several months, which uses a significant amount of CPU, and memory, and disk I/O resources. The importance measured is applied by an alteration degree in order to avoid a redundant DT calculation for each set of metric data. Instead of reading months of recorded metric data each time a DT is calculated, methods include collecting a set of metric data over a much shorter period of time, such as I or 2 days, and based on a change point detection method, a decision is made as to whether or not to perform DT calculation on the set of metric data over a much longer period of time. The assumption is that for most sets of metric data, DT's will not change over short periods of time, such as 1 day or 2 days. Therefore, by reading a set of metric data recorded over a much shorter period time instead of reading a set of metric data over a much longer period of time (e.g., 1 day versus 3 months) significantly less disk I/O, CPU and memory resources of the data center are used. In order to determine whether or not to calculate a DT for a set of metric data, a data-to-DT relation is calculated for the set of metric over a short period and compared with a data-to-DT relation calculated during a previous DT calculation over a much longer period of time.

If a set of metric data shows little variation from historical behavior, then there may be no need to re-compute the thresholds. On the other hand, determining a time to recalculate thresholds in the case of global or local changes and postponing recalculation for conservative data often decreases complexity and resource consumption, minimizes the number of false alarms and improves accuracy of recommendations.

A data-to-DT relation may be computed as follows:

$$f ( P , S ) = \frac{{e}^{aP}}{{e}^{a}} \frac{S}{{S}_{max}} \qquad ( 22 )$$

where
a>0 is a sensitivity parameter (e.g., a=10);
P is a percentage or fraction of metric data values that lie between upper and lower thresholds over a current time interval [tₛₜₐᵣₜ,y_{end}];
Sₘₐₓ is the area of a region defined by an upper threshold, U, and a lower threshold, L, and the current time interval [tₛₜₐᵣₜ,y_{end}]; and
S is the square of the area between metric values within the region and the lower threshold.
   The data-to-DT relation has the property that 0≦f(P,S)≦1. The data-to-DT relation may be computed for dynamic or hard thresholds.

When the upper and lower thresholds are hard thresholds, an area of a region, Sₘₐₓ, may be computed as follows:

Sₘₐₓ=(t_{end}−tₛₜₐᵣₜ)(U−L) (23)

An approximate square of the area, S, between metric values in the region and a hard lower threshold may be computed as follows:

$$S = \frac{1}{2} {\sum }_{k = 1}^{M - 1} ( {x}_{k + 1} + {x}_{k} - 2 l ) ( {t}_{k + 1} - {t}_{k} ) \qquad ( 24 )$$

where
M is the number metric values with time stamps in the time interval [tₛₜₐᵣₜ,t_{end}];
tₛₜₐᵣₜ=t₁; and
t_{end}=t_{M}.

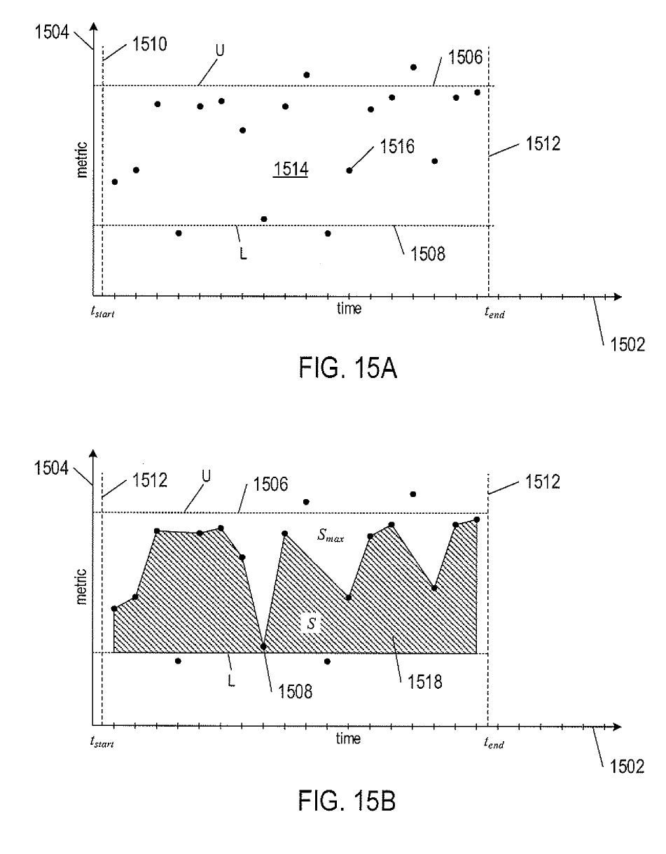

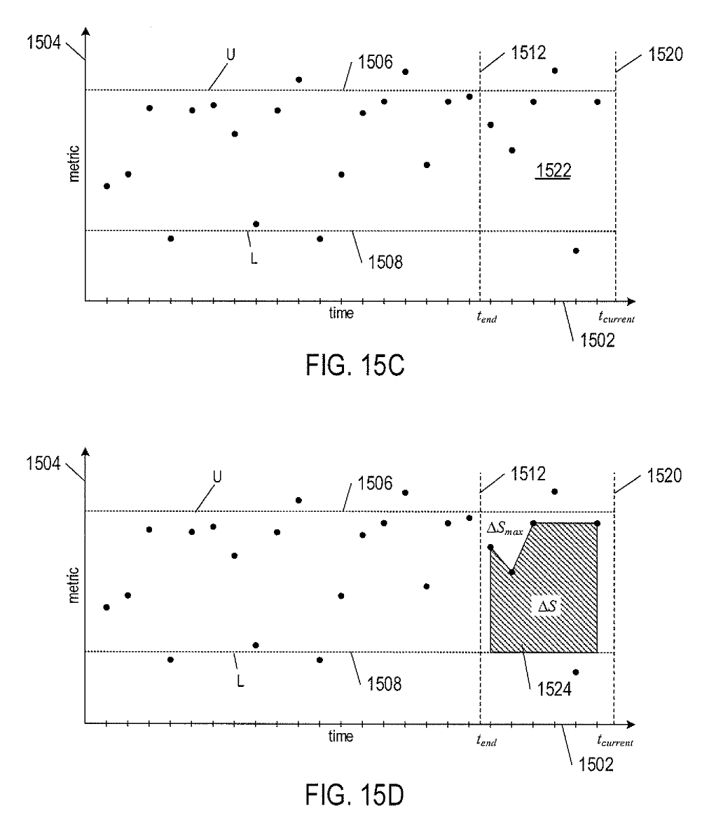

FIGS. 15A-15B show an example of calculating a data-to-DT relation for a set of metric data within a region defined by an upper threshold U and a lower threshold L over a historical time interval [tₛₜₐᵣₜ,t_{end}]. Horizontal axis 1502 represents time. Vertical axis 1504 represents a range of metric values. Dashed line 1506 represents an upper threshold, U, and dashed line 1508 represents a lower threshold, L. Dashed line 1510 represents start time tₛₜₐᵣₜ and dashed line 1512 represents end time t_{end} for the time interval [tₛₜₐᵣₜ,t_{end}]. The upper and lower thresholds and the current time interval define a rectangular region 1514. Dots, such as solid dot 1516, represent metric values with time stamps in the time interval [tₛₜₐᵣₜ,t_{end}]. In FIG. 15A, the percentage of metric data Pin the region 1514 is 77.8%. In FIG. 15B, the area of the rectangular region Sₘₐₓ is computed according to Equation (24). Shaded area 1518 represent areas between metric values in the region 1514 and the lower threshold 1508.

The data-to-DT relation is computed for a current time interval and compared with a previously computed data-to-DT relation for the same metric but for an earlier time interval. FIGS. 15C-15D show an example of calculating a data-to-DT relation for a set of metric data within a current time interval [t_{end},t_{current}]. Dashed line 1520 represents a current time t_{current}. The upper and lower thresholds and the current time interval [t_{end},t_{current}] define a rectangular region 1522. In FIG. 15C, the percentage of metric data AP in the region 1522 is 66.7%. In FIG. 15C, the area of the rectangular region ΔSₘₐₓ is also computed according to Equation (24). Shaded area 1524 represent area ΔS between metric values in the region 1524 and the lower threshold 1508. A data-to-DT relation is calculated for the current time interval as follows:

$$f ( P + Δ P , S + Δ S ) = \frac{{e}^{a ( P + Δ P )}}{{e}^{a}} \frac{( S + Δ S )}{Δ {S}_{max}} \qquad ( 25 )$$

When the following alteration degree is satisfied,

|f(P,S)−f(P+ΔP,S+ΔS)|>ε_{g} (26)

where ε_{g} is an alteration threshold (e.g., ε_{g}=0.1),

the set of metric data has changed with respect to normalcy ranges represented by upper and lower thresholds. As a result, the upper and lower thresholds should be updated. Otherwise, current upper and lower threshold should be maintained. In other words, previously computed dynamic thresholds are recalculated until the data-to-DT relation for the entire data set remains stable (i.e., the alteration degree is less than the alteration threshold).

When the upper and lower thresholds are dynamic thresholds, an approximate area of the region, Sₘₐₓ, defined by the dynamic upper and lower thresholds and the time interval may be computed as follows:

$${S}_{max} = {\sum }_{k = 1}^{M - 1} ( {u}_{k + 1} - {l}_{k + 1} ) ( {t}_{k + 1} - {t}_{k} ) \qquad ( 27 )$$

An approximate square of an area, S, between metric values in the region and a dynamic lower threshold may be computed as follows:

$$S = \frac{1}{2} {\sum }_{k = 1}^{M - 1} ( ( {x}_{k + 1} - {l}_{k + 1} ) + ( {x}_{k} - {l}_{k} ) ) ( {t}_{k + 1} - {t}_{k} ) \qquad ( 28 )$$

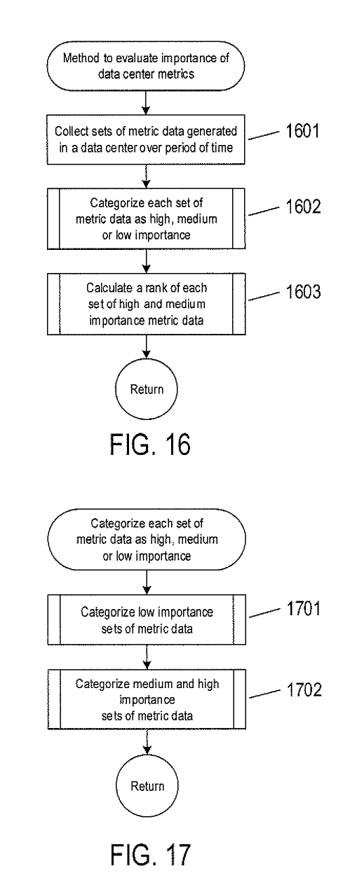

FIG. 16 shows a flow diagram of a method to evaluate importance of data center metrics. In block 1601, sets of metric data generated by objects of a data center are collected over a period of time. In block 1602, a routine “categorize each set of metric data as high, medium, or low importance” is called to evaluate each set of metric data. In block 1603, a routine “calculate a rank of each set of high and medium importance metric data” is called to rank each high and medium importance metric data categorized in block 1602.

FIG. 17 shows a flow diagram of the routine “categorize each set of metric data as high, medium, or low importance” called in block 1602. In block 1701, a routine “categorize low importance sets of metric data” is called to identify and categorize low importance sets of metric data. In block 1702, a routine “categorize medium and high importance sets of metric data” is called to identify and categorize medium and high importance sets of metric data.

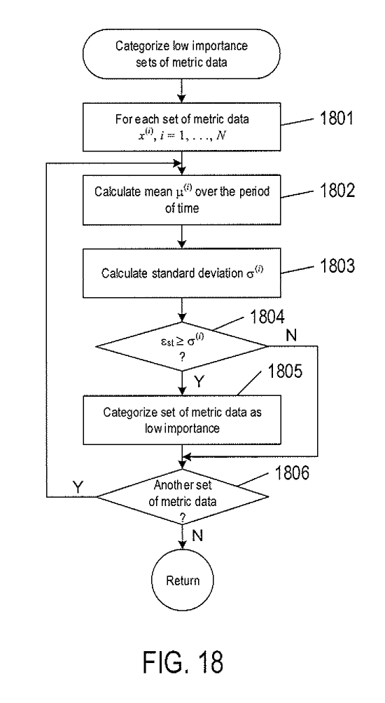

FIG. 18 shows a control-flow diagram of the routine “categorize low importance sets of metric data” called in block 1701 of FIG. 17. A for-loop beginning with block 1801 repeats the operations represented by blocks 1802-1806 for each set of metric data. In block 1802, a mean value is calculated for the set of metric data as described above with reference to Equation (4b). In block 1803, a standard deviation is calculated for the set of metric data as described above with reference to Equation (4a). In decision block 1804, when the standard deviation is less than or equal to a low-variability threshold, control flows to block 1805. Otherwise, control flows to decision block 1806.

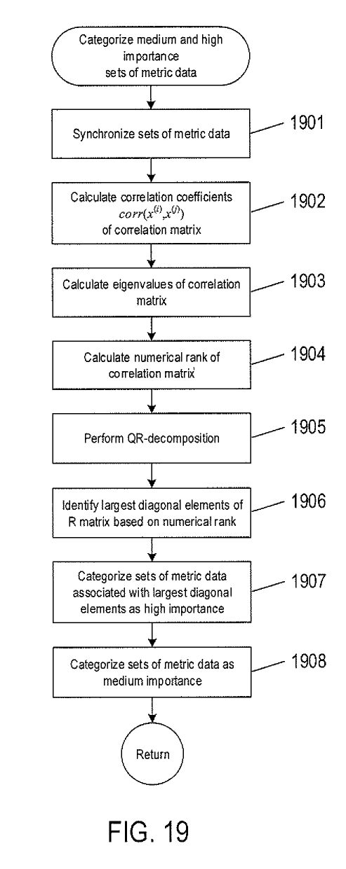

FIG. 19 shows a control-flow diagram of the routine “categorize medium and high importance sets of metric data” called in block 1702 of FIG. 17. In block 1901, the sets of metric data time stamp synchronized as described above with reference to FIGS. 8A-8B. In block 1902, elements of correlation matrix are calculated from the time synchronized sets of metric data as described above with reference to Equation (8). In block 1903, eigenvalues of the correlation matrix are calculated as described above with reference to Equation (9). In block 1904, the number rank in of the correlation matrix is calculated based on the number of non-zero eigenvalues of the correlation as described above with reference to Equation (10). In block 1905, QR-decomposition is performed on the correlation matrix to generate a Q-matrix and an R-matrix as described above with reference to Equations (12a)-(12d). In block 1906, the largest diagonal elements of the R-matrix are identified and sorted according to magnitude as described above with reference to Equation (13). In block 1907, sets of metric data associated with the largest magnitude diagonal elements of the R-matrix are categorized as high importance. In block 1908, sets of metric data that have not been categorized as high importance or low importance are categorized as medium importance.

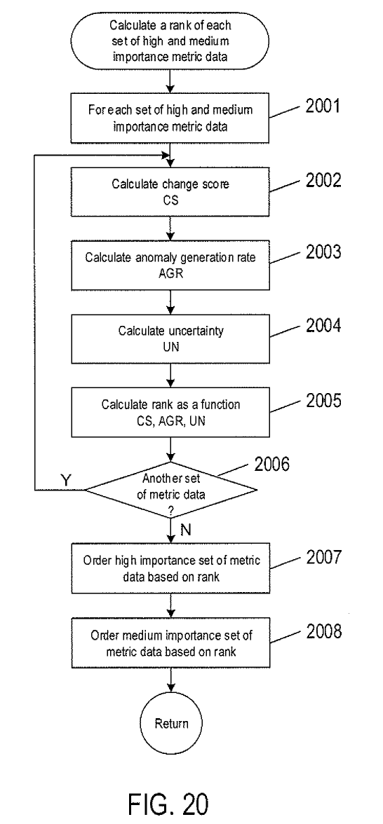

FIG. 20 shows a control-flow diagram of the routine “calculate a rank of each set of high and medium importance metric data” called in block 1603 of FIG. 16. A for-loop beginning with block 2001 repeats the operations represented by blocks 2002-2006 for each set of medium and high importance metric data. In block 2002, a change score (“CS”) is calculated as described above with reference to Equation (14). In block 2003, an anomaly generation rate (“AGR”) is calculated as described above with reference to Equation (15). In block 2004, an uncertainty (“UN”) is calculated as described above with reference to Equation (16). In block 2005, a rank is calculated for the metric using either Equation (17) or Equation (18). In decision block 2006, blocks 2002-2005 are repeated for another set of medium or high importance metric data. In block 2007, sets of metric data categorized as high importance are sorted and ordered according to rank. In block 2008, sets of metric data categorized as medium importance are sorted and ordered according to rank.

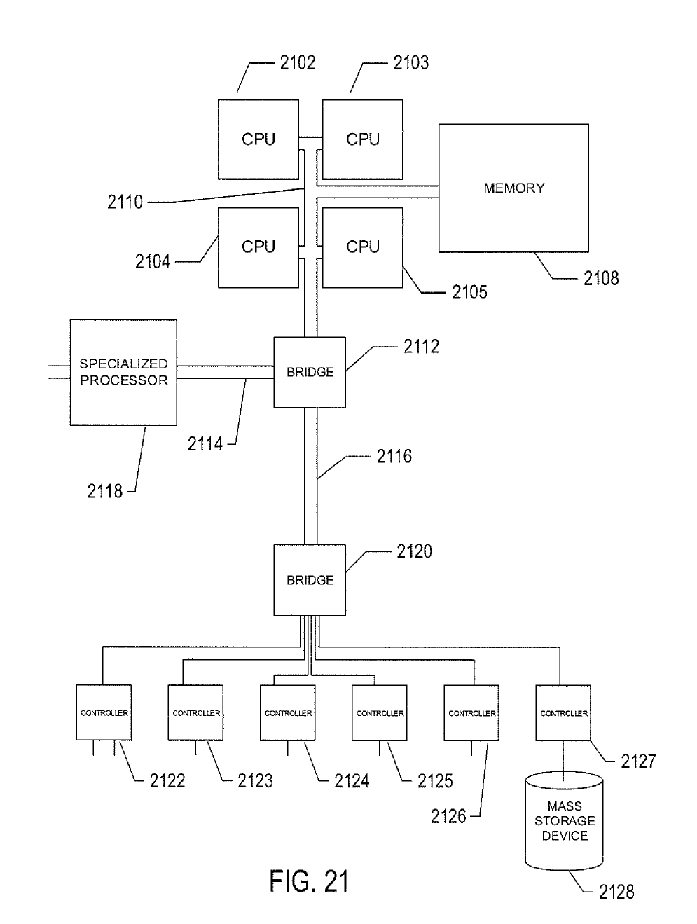

FIG. 21 shows an architectural diagram for various types of computers that may be used to evaluate importance of data center metrics. Computers that receive, process, and store event messages may be described by the general architectural diagram shown in FIG. 21, for example. The computer system contains one or multiple central processing units (“CPUs”) 2102-2105, one or more electronic memories 2108 interconnected with the CPUs by a CPU/memory-subsystem bus 2110 or multiple busses, a first bridge 2112 that interconnects the CPU/memory-subsystem bus 2110 with additional busses 2114 and 2116, or other types of high-speed interconnection media, including multiple, high-speed serial interconnects. These busses or serial interconnections, in turn, connect the CPUs and memory with specialized processors, such as a graphics processor 2118, and with one or more additional bridges 2120, which are interconnected with high-speed serial links or with multiple controllers 2122-2127, such as controller 2127, that provide access to various different types of mass-storage devices 2128, electronic displays, input devices, and other such components, subcomponents, and computational devices. The methods described above are stored as machine-readable instructions in one or more data-storage devices that when executed cause one or more of the processing units 2102-2105 to carried out the instructions as described above. It should be noted that computer-readable data-storage devices include optical and electromagnetic disks, electronic memories, and other physical data-storage devices.

Experimental results revealed that 34-36% of sets of metric data can be stored with larger distortion and higher compression rate because of medium importance, which may impact data storage policies, such computer resources, in the data center storing with larger distortion those data sets that have low importance, thus saving more storage.

A principle behind event consolidation is that for all active events or alarms, events may be grouped from medium importance sets of metric data around events of high importance sets of metric data, which are the classification centroids. In particular, event consolidation may be carried out as follows:

(1) classify all active events (alarms) from high importance sets of metric data belonging to the same metric group;

(2) classify all active events from medium importance sets of metric data belonging to the same metric group; and

(3) attach the active events class of (2) to the active events class (1) to create a two-layer recommendation representation.

Methods described above may be implemented in a data center management tool in order to reduce alarm recommendation noise, which enables guidance for datacenter customers to optimal remediation planning in view of consolidated recommendations with clusters of related events. Data center IT administrators are aware of other workflows that might be impacted.

There are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

It is appreciated that the various implementations described herein are intended to enable any person skilled in the art to make or use the present disclosure. Various modifications to these implementations will be readily apparent to those skilled in the art, and the generic principles defined herein may be applied to other implementations without departing from the spirit or scope of the disclosure. For example, any of a variety of different implementations can be obtained by varying any of many different design and development parameters, including programming language, underlying operating system, modular organization, control structures, data structures, and other such design and development parameters. Thus, the present disclosure is not intended to be limited to the implementations described herein but is to be accorded the widest scope consistent with the principles and novel features disclosed herein.

1. A method to evaluate importance of data center metrics, the method comprising:
collecting sets of metric data generated in a data center over a period of time;
categorizing each set of metric data as being of high importance, medium importance, or low importance; and
calculating a rank of each set of high importance and medium importance metric data.

2. The method of claim 1, wherein categorizing each set of metric data further comprises:
for each set of metric data,
calculating a mean value of a set of metric data over a period of time;
calculating a standard deviation of the set of metric data over the period of time based on the mean value of the set of metric data;
when the standard deviation is below a low-variability threshold, categorizing the set of metric data as a low-importance metric.

3. The method of claim 1, wherein categorizing each set of metric data further comprises:
synchronizing time stamps of the sets of metric data;
calculating a correlation matrix of the sets of metric data;
calculating eigenvalues of the correlation matrix;
calculating numerical rank of the correlation matrix;
decomposing the correlation matrix into a Q-matrix and a diagonal R-matrix using QR decomposition;
determining magnitude of each diagonal element of the R-matrix;
determining largest magnitude diagonal matrix elements of the R-matrix based on the numerical rank of the correlation matrix; and
categorizing sets of metric data associated with the largest magnitude diagonal matrix elements as high importance sets of metric data.

4. The method of claim 3 further comprising categorizing sets of metric data not associated with the largest magnitude diagonal matrix elements and having standard deviations greater than a low-variability threshold as medium importance sets of metric data.

5. The method of claim 1, wherein calculating the rank of each set of high importance and medium importance metric data further comprises:
for each set of medium and high importance metric data,
calculating a change score over the period of time;
calculating an anomaly generation rate over the period of time;
calculating an uncertainty over the period of time based on entropy; and
calculating a rank as a function of the change score, anomaly generation rate, and the uncertainty;
ordering each high importance set of metric from highest rank to lower rank; and
ordering each medium importance set of metric from highest rank to lower rank.

6. The method of claim 1, wherein the sets of metric further comprise sets of metrics associated with an object of the data center.

7. The method of claim 1, wherein the sets of metric further comprise attributes generated by objects of the data center.

8. The method of claim 1 further comprising:
calculating a first data-to-dynamic-threshold relation for a set of metric data over the period of time;
calculating a second data-to-dynamic-threshold relation for the set of metric data over a current period of time;
calculating an alteration degree as the absolute value of the different between the first and second data-to-dynamic-threshold relations; and
when the alteration degree is greater than an alteration threshold, the set of metric data is identify as having changed with respect to normalcy bounds.

9. A system to evaluate importance of data center metrics, the system comprising:
one or more processors;
one or more data-storage devices; and
machine-readable instructions stored in the one or more data-storage devices that when executed using the one or more processors controls the system to carry out
collecting sets of metric data generated in a data center over a period of time;
categorizing each set of metric data as being of high importance, medium importance, or low importance; and
calculating a rank of each set of high importance and medium importance metric data.

10. The system of claim 9, wherein categorizing each set of metric data further comprises:
for each set of metric data,
calculating a mean value of a set of metric data over a period of time;
calculating a standard deviation of the set of metric data over the period of time based on the mean value of the set of metric data;
when the standard deviation is below a low-variability threshold, categorizing the set of metric data as a low-importance metric.

11. The system of claim 9, wherein categorizing each set of metric data further comprises:
synchronizing time stamps of the sets of metric data;
calculating a correlation matrix of the sets of metric data;
calculating eigenvalues of the correlation matrix;
calculating numerical rank of the correlation matrix;
decomposing the correlation matrix into a Q-matrix and a diagonal R-matrix using QR decomposition;
determining magnitude of each diagonal element of the R-matrix;
determining largest magnitude diagonal matrix elements of the R-matrix based on the numerical rank of the correlation matrix; and
categorizing sets of metric data associated with the largest magnitude diagonal matrix elements as high importance sets of metric data.

12. The system of claim 11 further comprising categorizing sets of metric data not associated with the largest magnitude diagonal matrix elements and having standard deviations greater than a low-variability threshold as medium importance sets of metric data.

13. The system of claim 9, wherein calculating the rank of each set of high importance and medium importance metric data further comprises:
for each set of medium and high importance metric data,
calculating a change score over the period of time;
calculating an anomaly generation rate over the period of time;
calculating an uncertainty over the period of time based on entropy; and
calculating a rank as a function of the change score, anomaly generation rate, and the uncertainty;
ordering each high importance set of metric from highest rank to lower rank; and
ordering each medium importance set of metric from highest rank to lower rank.

14. The system of claim 9, wherein the sets of metric further comprise sets of metrics associated with an object of the data center.

15. The system of claim 9, wherein the sets of metric further comprise attributes generated by objects of the data center.

16. The system of claim 9 further comprising:
calculating a first data-to-dynamic-threshold relation for a set of metric data over the period of time;
calculating a second data-to-dynamic-threshold relation for the set of metric data over a current period of time;
calculating an alteration degree as the absolute value of the different between the first and second data-to-dynamic-threshold relations; and
when the alteration degree is greater than an alteration threshold, the set of metric data is identify as having changed with respect to normalcy bounds.

17. A non-transitory computer-readable medium encoded with machine-readable instructions that implement a method carried out by one or more processors of a computer system to perform the operations of
collecting sets of metric data generated in a data center over a period of time;
categorizing each set of metric data as being of high importance, medium importance, or low importance; and
calculating a rank of each set of high importance and medium importance metric data.

18. The medium of claim 17, wherein categorizing each set of metric data further comprises:
for each set of metric data,
calculating a mean value of a set of metric data over a period of time;
calculating a standard deviation of the set of metric data over the period of time based on the mean value of the set of metric data;
when the standard deviation is below a low-variability threshold, categorizing the set of metric data as a low-importance metric.

19. The medium of claim 17, wherein categorizing each set of metric data further comprises:
synchronizing time stamps of the sets of metric data;
calculating a correlation matrix of the sets of metric data;
calculating eigenvalues of the correlation matrix;
calculating numerical rank of the correlation matrix;
decomposing the correlation matrix into a Q-matrix and a diagonal R-matrix using QR decomposition;
determining magnitude of each diagonal element of the R-matrix;
determining largest magnitude diagonal matrix elements of the R-matrix based on the numerical rank of the correlation matrix; and
categorizing sets of metric data associated with the largest magnitude diagonal matrix elements as high importance sets of metric data.

20. The medium of claim 19 further comprising categorizing sets of metric data not associated with the largest magnitude diagonal matrix elements and having standard deviations greater than a low-variability threshold as medium importance sets of metric data.

21. The medium of claim 17, wherein calculating the rank of each set of high importance and medium importance metric data further comprises:
for each set of medium and high importance metric data,
calculating a change score over the period of time;
calculating an anomaly generation rate over the period of time;
calculating an uncertainty over the period of time based on entropy; and
calculating a rank as a function of the change score, anomaly generation rate, and the uncertainty;
ordering each high importance set of metric from highest rank to lower rank; and
ordering each medium importance set of metric from highest rank to lower rank.

22. The medium of claim 17, wherein the sets of metric further comprise sets of metrics associated with an object of the data center.

23. The medium of claim 17, wherein the sets of metric further comprise attributes generated by objects of the data center.

24. The medium of claim 17 further comprising:
calculating a first data-to-dynamic-threshold relation for a set of metric data over the period of time;
calculating a second data-to-dynamic-threshold relation for the set of metric data over a current period of time;
calculating an alteration degree as the absolute value of the different between the first and second data-to-dynamic-threshold relations; and
when the alteration degree is greater than an alteration threshold, the set of metric data is identify as having changed with respect to normalcy bounds.
